(19) United States
(12) Patent Application Publication
(10) Pub. No.: US 2011/0189931 A1
(43) Pub. Date: Aug. 4, 2011

(54) Combination Tool Used to Kill, Scale, and Gut Fish

(76) Inventor: Michael David Nuriel, Orlando, FL (US)

(21) Appl. No.: 12/984,625

(22) Filed: Jan. 5, 2011

Related U.S. Application Data
(60) Provisional application No. 61/292,602, filed on Jan. 6, 2010.

(51) Int. Cl. A22C 25/02

(52) U.S. Cl. 452/103

(57) ABSTRACT

The present invention is a fish cleaning tool incorporating a fishhook remover, a fish scaler and collector, a method for safely cutting open a fish, means for removing fish innards, and a means for killing a fish. The present invention is buoyant. In addition to adding functionality to prior art items, the present invention also improves upon the storage and safety concerns created with prior art items.

### CROSS-REFERENCE RELATED APPLICATIONS

Previously filed Provisional Application No. 61/292,602 on Jan. 6, 2010 (Jan. 06, 2010).

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

1. Field of the Invention

The present invention relates to fish cleaning devices. Specifically, the present invention pertains to a new fish cleaning apparatus that allows multiple steps of cleaning a fish to be completed with a single tool.

2. Description of the Prior Art

Tools used to facilitate the cleaning of fish are well established as prior art. There are patents pertaining to the cleaning of fish dating back to the early 20^{th} century (Patent # 669,353—Fish Cleaner—Issued in 1901). While some patents focus solely on singular improvements to a fish scaling device (U.S. Pat. Nos. 3,048,884; 3,270,368), a greater portion attempt to combine multiple functions into one tool. A common combination of tools is a scaler and a knife blade (U.S. Pat. No. 1,788,656; ∩717,408). There are other prior art references, such as U.S. Pat. No. 2,434,550 and 6,607,430 that implement a myriad of components into a single tool.

Each of these references has limited functionality in real world applications. Some of them lack safety features. Others have ergonomic flaws. Yet others suffer from size and shape constraints, ultimately limiting their capability to be stored in a pocket or a tackle box. The present invention provides a safe approach to a multi-function fish cleaning apparatus that can be easily stored and quickly retrieved to complete a large variety of fish cleaning tasks.

### BRIEF SUMMARY OF THE INVENTION

Due to the abundance of water and its relaxing nature, fishing is a very popular activity. The fact that over $40 billion are spent annually on recreational fishing is a testament to the popularity of the sport. While there are many, many fishing variations (freshwater fishing, fly fishing, wade fishing, net fishing, etc., etc.), they all have one thing in common—every fish must be cleaned before being eaten.

As most fishermen will attest, the cleaning of fish is not the most glamorous, nor the most enjoyable part of any fishing experience. When scaling a fish, the scales become scattered and end up covering a large area, requiring additional clean-up after the cleaning of the fish is complete. The gutting of the fish requires additional labor and creates an additional mess. To this end, any tool or technique that can help fishermen gut and clean fish quicker or more efficiently will gain acceptance quickly in the fishing community.

The object of the present invention is to allow for a more efficient process of cleaning fish. The present invention is a simple tool that incorporates multiple aspects of fish cleaning into one basic device. This device packages an ergonomically designed fish scaler, an integrated knife for gutting, a hook removal tool, a line cutting tool, and an integrated knife for fin removal into a single buoyant casing. The tool is small enough to fit into a fisherman's back pocket or their tackle box, making it a unique solution for most any fish cleaning application.

Unlike the tools detailed in the background of the invention, the present invention provides a simple and safe “all-in-one” solution for the various tasks associated with cleaning a fish. Unlike the prior art, the blade is not exposed, greatly reducing the risk of bodily harm. In addition, the finger indentions along the sides of the tool further add to the safety of the tool, preventing any slippage while handling the tool. The fish scaler on the unit has a scoop, allowing for the collection of the scales, preventing the haphazard and potentially harmful ejection of scales. The present invention's buoyancy is also a marked improvement over previous fish cleaning tools.

### BRIEF DESCRIPTION OF THE SEVERAL VIEWS OF THE DRAWINGS

FIG. 1 shows a top view of the tool.

FIG. 2 shows a side view of the tool.

FIG. 3 shows a front view of the tool.

FIG. 4 shows a rear view of the tool.

FIG. 5 shows a perspective view of the tool.

### DETAILED DESCRIPTION OF THE INVENTION

The present invention is designed to work with both right-handed and left-handed fishermen. The tool may be grasped and held much like a utility knife. The contoured handle prevents slippage, and, in the event that it does slip from the angler's grasp, the tool is buoyant, allowing for easy retrieval. When held, the tool is instantly operable. The simplicity of the design requires only that the user rotate the apparatus from one end to the other to use it for any of the present invention's various purposes and functions.

The present invention will be similar to a standard utility knife in shape and size. Unlike a utility knife, the apparatus has a recessed blade (3) that is always exposed. The recessed blade (3) is similar to that of a standard letter opener. The present invention has a blade at the rearward most point of the blade opening (2). The blade (3) is recessed, allowing it to be readily available without the dangers associated with an open blade.

The shape and design of the rear lower portion of the tool (referred to as the “hook”) (5) leading into the blade (3) is intended to facilitate safe and efficient slicing of a fish. The blade opening (2) design is paired with the blade (3) at a specified angle to better slice the fish. The tool should be held and the tip of the blade opening (5) inserted into the anus of the fish. Once the tip is inserted into the anus, the tool can be run along the bottom of the fish, slicing as it moves. The blade opening (2) is large enough to allow for cutting to continue around the fins of the fish in addition to the clavicle of the fish.

The blade (3) can also be used to remove fins from the fish. The area around the blade (2) is properly angled to allow for the insertion and cutting off of the fish's fins. While firmly holding the fin with one hand, the present invention can be positioned around the fin with the other hand, using the hook (5) and the contour of the tool's body as a guide to ensure safe and solid contact between the blade (3) and the base of the fin, before cutting and safely removing the fin.

On the same end of the tool as the hook (5) and blade (2) is a fishhook removal tool (1). This tool is comprised of a slit in the upper portion of the tool leading to a circular opening. When a fish is on a fishing line, the line is inserted through the slit and into the circular opening. The present invention is then moved directly down the fishing line until the upper portion of the fishhook is protruding through the opening in the tool (1). With the hook in the opening, a simple twist and shake of the tool will release the fishhook from the mouth of the fish.

In the event that the fishing line ever needs to be cut, the line can be fed into the blade opening (2) and the line will be severed upon contact with the blade (3).

On the opposite end of the present invention from the fishhook removal tool (1) and the cutting surface (2), is an angled fish scale scraper (6). The present invention's scraper allows the user to apply the necessary downward pressure without the risk of losing their grip or cutting their hand. The handle has indentions (7) for individual fingers, creating a safe, contoured grip. The scaling of the fish is achieved by a back and forth motion of the tool across the scales of the fish while applying downward pressure. As the scales are removed, they are collected inside the scraper's cavity (9). The teeth (8) on the scraper are of differing angles and sizes. The smaller teeth are positioned on the front face of the tool, allowing access into smaller areas. The teeth increase in size from the front of the scaler to the back of the scaler. The larger teeth have a wider base (creating a larger angle) and creating a more effective method for removing the larger scales.

The scale collection cavity (9) also serves a secondary purpose as a scraper and scoop to remove the unwanted innards of the fish. The finger indentions (7) on the tool allow for the tool to be used to apply pressure to the organs of the fish and provide an effective means for removal and disposal.

Above the scaler cavity (9) is a pronounced protrusion (4). This protrusion is designed to be used as a “bang stick”, allowing for a quick and humane method in which to kill the fish. By striking the fish over the head with the weighted protrusion of the present invention (4), the tool will deliver a sharp blow, killing the fish.

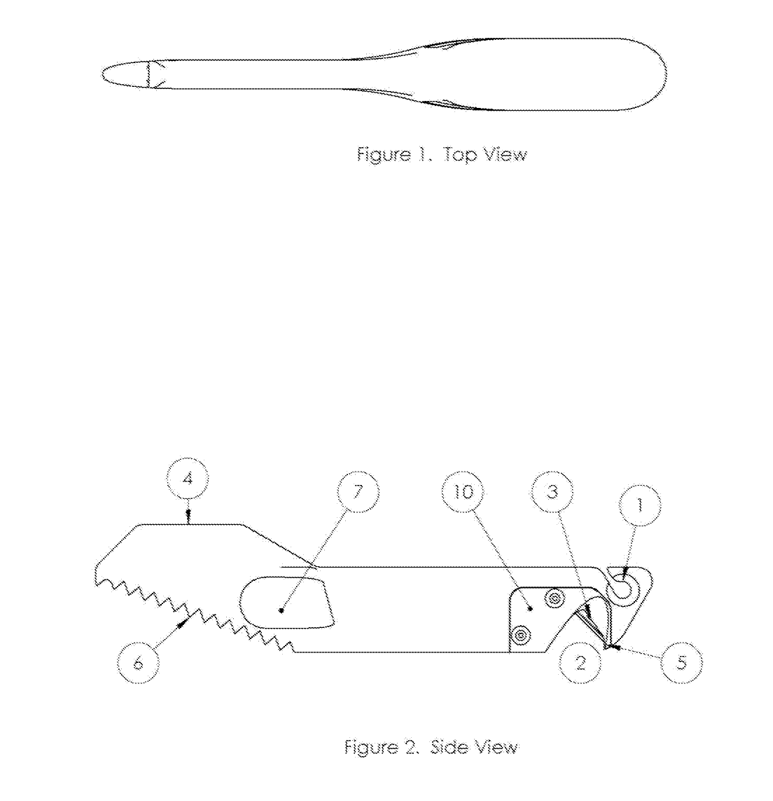

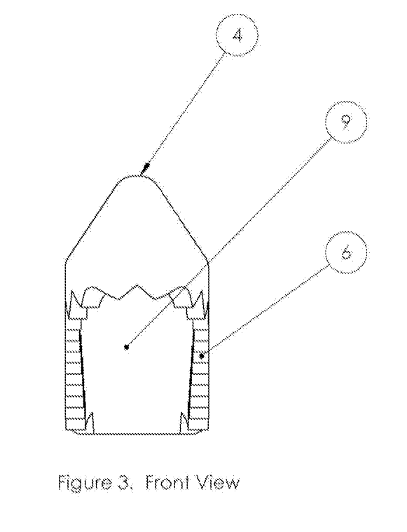

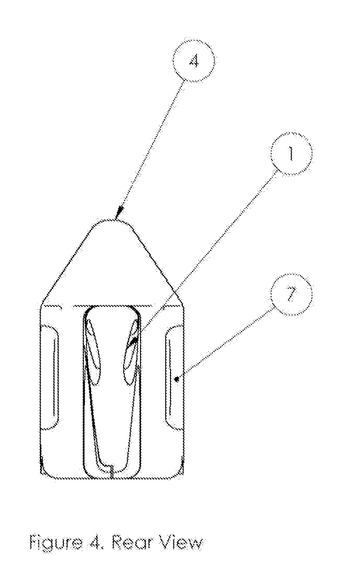

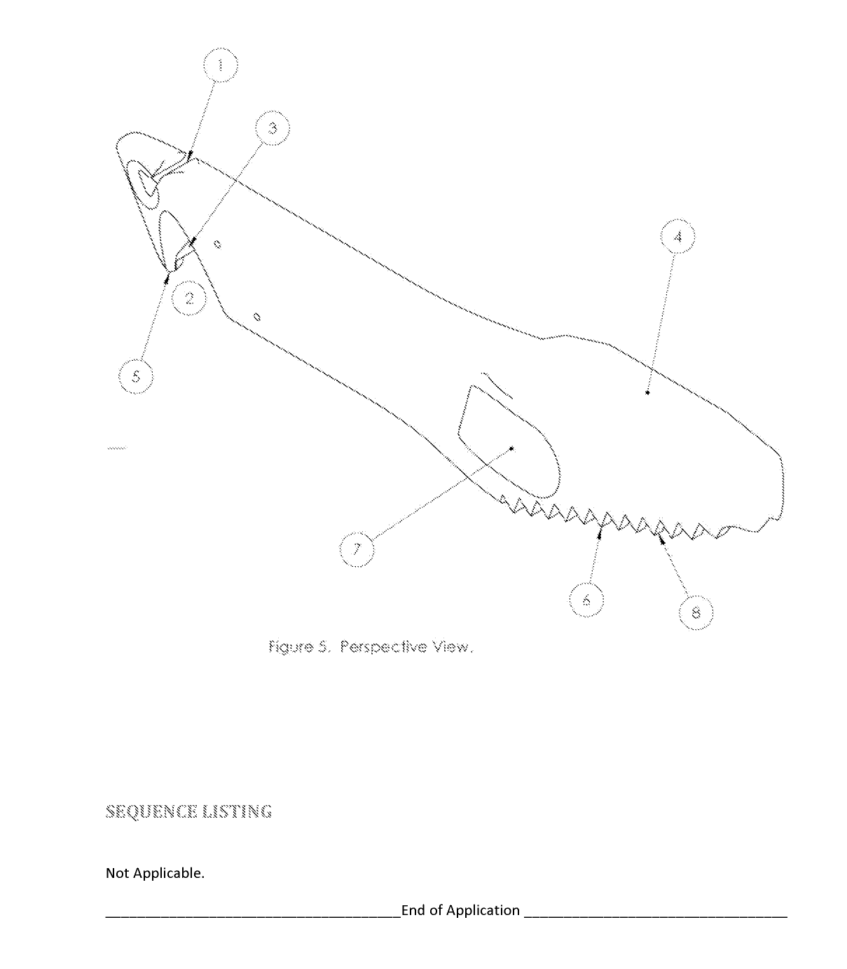

In the preferred embodiment, the grip (tool body), the scraper, and the blade casing (all portions of the present invention other than the blade) are made of plastic, allowing for infinite color variations as well as a uni-body design. The preferred embodiment has a single, smooth edged, non-replaceable blade, however, optional embodiments include interchangeable blades of different materials (ceramic blades, stainless steel blades, etc.) and different edge profiles (serrated edge, etc.). FIG. 2 shows one possible configuration for an interchangeable blade assembly (10).

As many changes could be made in the above construction and many apparently widely different embodiments of this invention could be made without departing form the scope thereof, it is intended that all matter contained in the above description or shown in the accompanying drawings shall be interpreted as illustrative and not in a limited sense.

It is also to be understood that the language used in the following claims is intended to cover all of the generic and specific features of the invention herein described and all statements of the scope of the invention which, as a matter of language, might be said to fall therebetween.

What is claimed:

1. A fish cleaning tool comprising:
A main contoured handle body, extending between a concave head portion and a tapered tail portion, all fixed in a static position relative to said other portions;
Said tool displaying buoyant properties relative to water.

2. A fish cleaning tool as set forth in claim 1 with said tapered tail portion from tool comprising:
Said tapered tail having a circular opening with chamfered edges;
Said tapered tail having a recessed cutting surface permanently fixed within the body cavity;
Said tapered tail having an angled opening leading from surface of body to recessed cutting surface.

3. A fish cleaning tool as set forth in claim 1 with said tapered tail portion from tool comprising:
Said tapered tail having a circular opening with chamfered edges;
Said tapered tail having an interchangeable recessed cutting surface fixed within the body cavity;
Said tapered tail having an angled opening leading from surface of body to recessed cutting surface.

4. A fish cleaning tool as set forth in claim 1 with said handle portion from tool comprising:
Said handle having permanently formed ovular depressions on both elongated body faces, capable of receiving human digits;
Said handle exhibiting a raised roughened pattern along any portion thereof of both elongated faces.

5. A fish cleaning tool as set forth in claim 1 with said head portion consisting of a central cavity rimmed with protrusions of varying heights and angles and capped with a weighted mass.
Said protrusions, being isosceles triangles in nature, increasing in vertex angle from the front of said cavity to rear of said cavity;
Said triangular protrusions having a uniform thickness;
Said head portion being capped with a weighted mass contained within a blunt shaped housing.

6. A fish cleaning tool as set forth in claim 1 with said head portion consisting of a central cavity rimmed with protrusions of varying heights and angles and capped with a weighted mass.
Said protrusions, being pyramidal in nature, increasing in vertex angle from the front of said cavity to rear of said cavity;
Said pyramidal protrusions having a uniform base thickness;
Said head portion being capped with a weighted mass contained within a blunt shaped housing.
